(19) United States
(12) Patent Application Publication
(10) Pub. No.: US 2011/0142275 A1
(43) Pub. Date: Jun. 16, 2011

(54) Sound generator

(76) Inventor: German Valencia, Miami, FL (US)

(21) Appl. No.: 12/654,213

(22) Filed: Dec. 14, 2009

(51) Int. Cl. H04R 1/02

(52) U.S. Cl. 381/334

(57) ABSTRACT

The sound generator includes a housing having a front cover, a back layer, and a peripheral wall defining a casing. An actuator, a control circuit, a sound emitter and a power source are mounted in the housing. The actuator is accessible by the user to selectively activate playback of pre-recorded sound via the control circuit. The sound generator may include selectively actuable lights for added visual appeal.

### BACKGROUND OF THE INVENTION

1. Field of the Invention

The present invention relates to adornments, more specifically, a sound generator for emitting pleasant sounds as an enhancement to gifts or packages.

2. Description of the Related Art

Gift-giving is a longstanding custom for positive social interaction. It helps to welcome guests and friends or pave the way for negotiations, and it provides a pleasant token of affection for one's significant other. While the gift itself is a boon, a gift with an additional personal touch has more positive impact on the recipient.

Many products exist for that additional personal acknowledgement. These generally comprise cards, ribbons and balloons with a note or message for the recipient. While such adornments have a certain degree of visual appeal from the design and/or personal message, they still lack a certain amount of sensory impact to make the gift especially memorable. Thus, it would be a benefit in the art to provide an adornment with aural and/or visual emitting means for memorable impact.

Thus, a sound generator solving the aforementioned problems is desired.

### SUMMARY OF THE INVENTION

The sound generator includes a housing having a front cover, a back layer, and a component mounting means sandwiched therebetween. An actuator, a control circuit means, a sound emitter and a power source are mounted in the mounting means. The actuator is accessible by the user to selectively activate playback of pre-recorded sound via the control circuit means. The sound generator may include selectively actuable lights for added visual appeal.

These and other features of the present invention will become readily apparent upon further review of the following specification and drawings.

### BRIEF DESCRIPTION OF THE DRAWINGS

FIG. 1 is an environmental, perspective view of a sound generator according to the present invention.

FIG. 2 is a perspective view of the sound generator according to the present invention.

FIG. 3 is another perspective view of the sound generator according to the present invention with the front cover removed.

FIG. 4 is a schematic diagram of the sound generator according to the present invention.

Similar reference characters denote corresponding features consistently throughout the attached drawings.

### DETAILED DESCRIPTION OF THE PREFERRED EMBODIMENTS

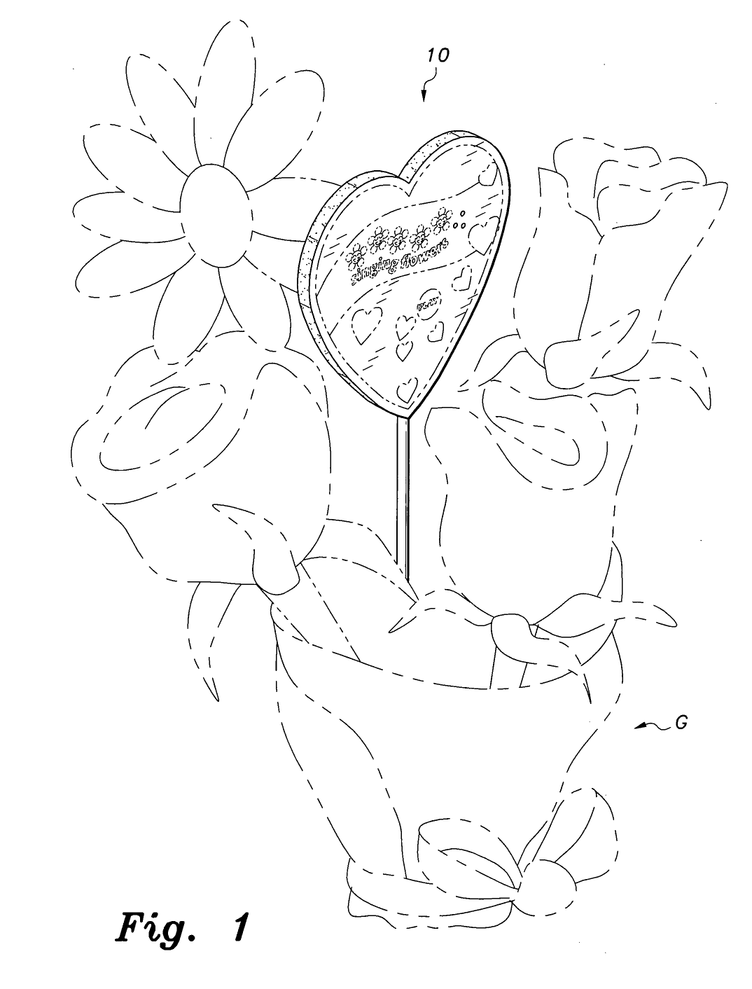

The present invention relates to a sound generator, generally referred to in the drawings by reference number 10, configured to produce preselected sounds upon activation of a switch. As shown in FIGS. 1-3, the sound generator 10 includes an adornment, attachment or housing comprised of a composite structure. The housing includes a front cover 12, a back cover 18, and a peripheral wall 16 extending between the front and back covers to define a casing. The housing may be in the form of a heart (as shown in FIGS. 1-3), but other celebratory or decorative shapes such as snowmen, bears, rabbits, four-leaf clovers, flowers, etc. may equally be employed. Both the front and back covers 12, 18 and/or the peripheral wall 16 may include a variety of indicia or visual designs representing a festival occasion or other personal messages. The front and back covers 12, 18 are preferably made from durable paper or cardboard, but other materials such as plastic, metal foil, wood or composites may also be used.

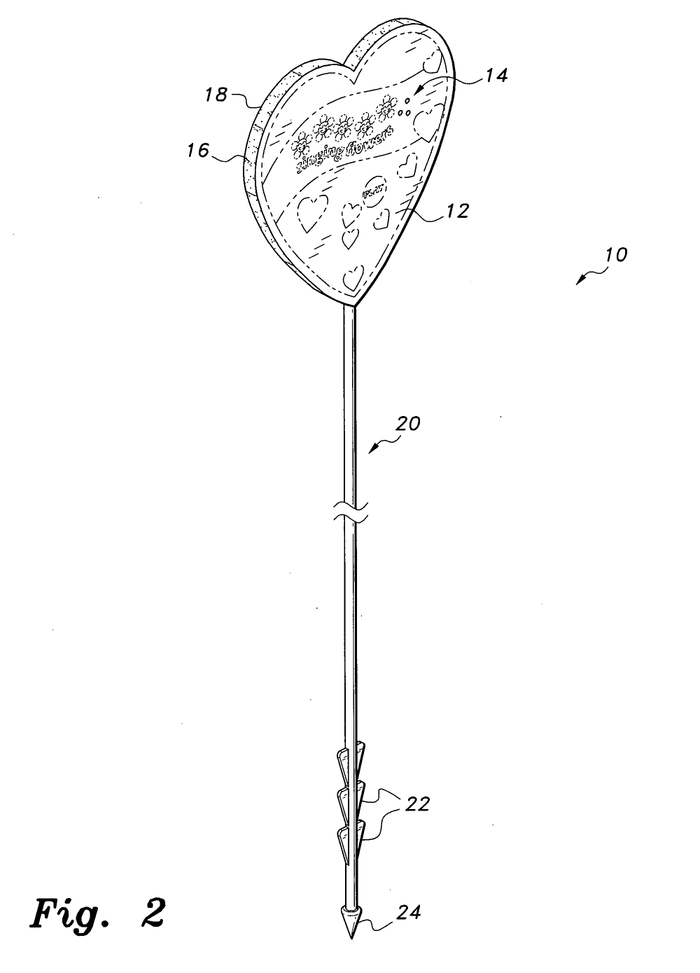

To clearly and positively present the adornment or housing, the sound generator 10 includes a mounting stick, rod or tube 20 detachably mounted to the housing. The mounting stick 20 is adapted to be insertably mounted to a gift G such as a bouquet of flowers. The mounting stick 20 includes a distal, pointed or sharpened end or conical tip 24 and a plurality of protruding barbs 22 disposed along the length of the mounting stick 20 adjacent the tip 24. The conical tip 24 permits easy insertion of the sound generator 10 while the barbs 22 obstruct easy removal of the sound generator 20. The barbs 22 may be triangular in shape (as shown in FIG. 2), but other similar obstructive shapes are feasible alternatives. The mounting stick 20 is preferably made from plastic, but other materials such as wood, paper, metal or composites may also be used.

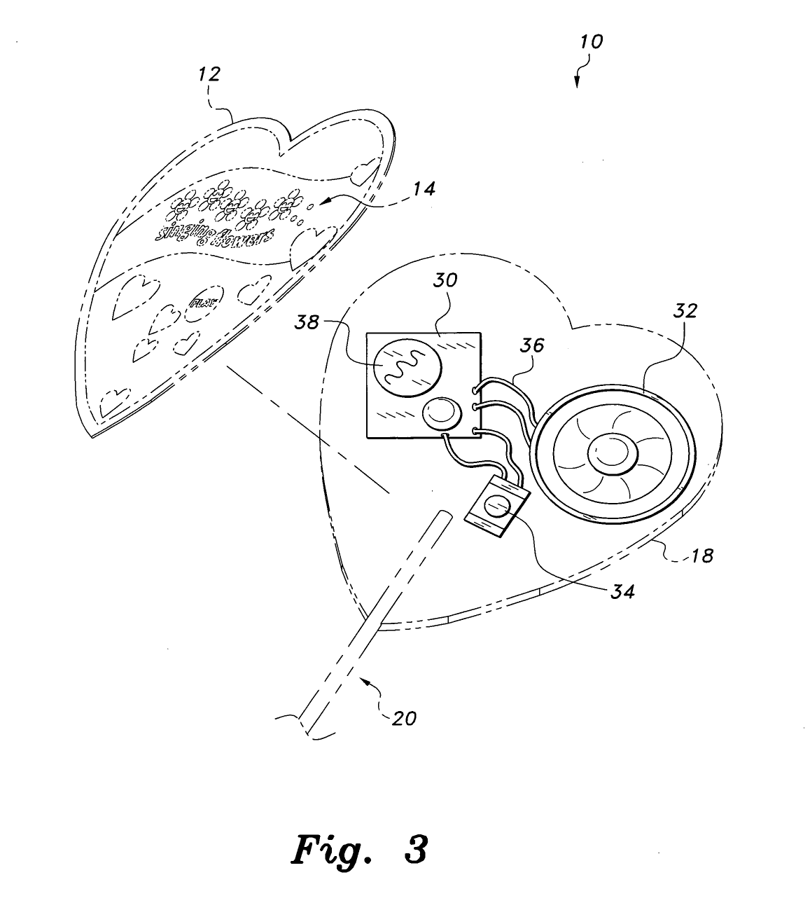

Referring to FIG. 3, the casing encloses or houses the components for generating preselected sounds. The casing may be made from plastic, foam, paper, cardboard, metal, wood or other similar materials that can mount the components and provide impact protection thereof for durability. The components include a switch 34, a control circuit means 30, a power source 38, a sound emitter 32 and wiring 36 embedded within recesses of the casing, and that may be mounted on or connected to a printed circuit board. Activation of the switch 34 causes the control circuit means 30 to generate pre-recorded audio signals that may be played back by the sound emitter or speaker 32. The front cover 12 may include a plurality of holes or a grill 14 permitting the sound to escape from the speaker 32.

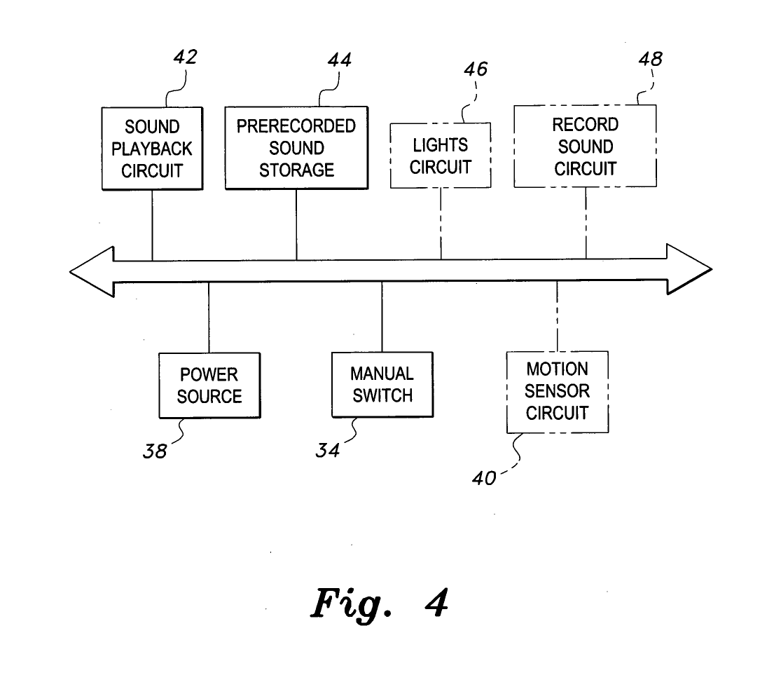

Referring to FIG. 4, the circuit control means 30 may be configured to provide a variety of different functions. At a minimum, the circuit control means 30 includes a pre-recorded sound storage 44 and a sound playback circuit 42. The pre-recorded sound storage 44 may include music or a voice message file for the recipient that can be played back via the playback circuit 42 with activation of the switch 34. Alternatively, the sound storage 44 may include a number of music or voice files that can be played back in a pre-selected order or randomly. Moreover, the control circuit means 30 may include recording capabilities via a record sound circuit 48. The record sound circuit 48 includes an integrated microphone for recording user-generated sound that overwrites or replaces a previous sound file for an even more personalized message.

In addition to the above, the control circuit 30 may further include a lights circuit 46. The sound generator 10 may include a light source or a plurality of light sources such as LEDs (Light Emitting Diodes) operatively connected to the lights circuit 46, which, upon activation of the sound generator 10, flashes in different colors and/or patterns. The lights display may be configured to operate alone or in sync with the sounds emitting from the speaker 32. In this manner, the sound generator 10 provides both aural and visual impact to the recipient of the adornment.

In the preferred embodiment, the sound generator 10 includes the manual switch 34. However, the sound generator 10 may also include other types of switches, such as a motion sensor 40 that operates in conjunction with or separately from the manual switch 34 to activate the sound generator 10.

It is to be understood that the sound generator 10 includes a variety of alternatives. For example, the power source 38 for the sound generator 10 may be a battery embedded in the control circuit means 30. However, power may also be supplied via external sources such as an outlet or an external battery pack. Moreover, the housing may include a removable frame wherein the user may place photos. Alternatively, the removable frame may be replaced with an electronic display, e.g., an LCD panel, for displaying the photos.

It is to be understood that the present invention is not limited to the embodiments described above, but encompasses any and all embodiments within the scope of the following claims.

I claim:

1. A sound generator, comprising:
a housing having a front cover, a back cover, and a peripheral wall extending between the front cover and the back cover;
a sound generating means disposed in the housing for generating sound, the sound generating means having;
a control circuit for storing sounds and generating sound signals;
a switch operatively connected to the control circuit;
a power source; and
a sound emitter for reproducing the sound signals generated by the control circuit; and
a mounting rod adapted for insertably mounting the sound generator to a gift;
wherein activation of the switch causes the control circuit to produce pre-recorded sound signals to be played back via the sound emitter.

2. The sound generator according to claim 1, wherein the housing is shaped as a heart.

3. The sound generator according to claim 1, wherein the control circuit further comprises a lights circuit for generating preselected patterns of lights.

4. The sound generator according to claim 1, wherein the control circuit further comprises a sound recording circuit for generating and storing user-defined sounds.

5. The sound generator according to claim 1, wherein the control circuit further comprises a motion sensor for activating the control circuit.

6. The sound generator according to claim 1, wherein the power source is a battery.

7. The sound generator according to claim 1, wherein the mounting rod comprises:
an elongate rod mounted to the housing at one end;
a conical tip disposed at the opposite end adapted for easy insertable mounting of the sound generator into a gift; and
a plurality of barbs adjacent the conical tip, the plurality of barbs obstructing easy removal of the sound generator when inserted.
